(19) United States
(12) Patent Application Publication
(10) Pub. No.: US 2005/0219845 A1
(43) Pub. Date: Oct. 6, 2005

(54) Illumination system with improved optical efficiency

(76) Inventors: Gregory Cutler, Cupertino, CA (US); Andrew Huibers, Palo Alto, CA (US)

Correspondence Address: REFLECTIVITY, INC., 350 POTRERO AVENUE, SUNNYVALE, CA, 94085, US

(21) Appl. No.: 11/055,334

(22) Filed: Feb. 9, 2005

Related U.S. Application Data
(60) Provisional application No. 60/643,237, filed on Jan. 12, 2005.
(60) Provisional application No. 60/612,096, filed on Sep. 21, 2004.
(60) Provisional application No. 60/543,237, filed on Feb. 9, 2004.

(51) Int. Cl. F21K 2/00

(52) U.S. Cl. 362/261; 362/262; 362/341; 362/346; 362/347

(57) ABSTRACT

The present invention provides an illumination system having a light source for emitting light and a reflector having a reflective surface for collecting and reflecting the light from the light source.

### CROSS-REFERENCE TO RELATED APPLICATIONS

The present application claims priority of provisional U.S. patent applications: a) Ser. No. 60/643,237 to Cutler filed Feb. 9, 2004; and b) Ser. No. 60/612,096 to Cutler filed Sep. 21, 2004, the subject matter of each being incorporated herein by reference in entirety.

### TECHNICAL FIELD OF THE INVENTION

The present invention is related generally to the art of illumination systems, and, more particularly, to illumination systems used in display systems.

### BACKGROUND OF THE INVENTION

Condenser optics are used in transforming the near field areal extent and far field angular extent into extents of greater utility for optical devices with specific source requirements. A four dimensional phase space can be defined wherein two of the dimensions are comprised of the near field areal extent and the other two dimensions are comprised of the far field angular extent. An ideal optical condenser transforms the near field and far field extents such that the volume of the phase space is conserved from optical source to condenser output. A less than ideal condenser provides output of greater phase space volume than that of the transformed portion of the source. Additionally, an ideal condenser, while preserving phase space volume, conserves energy by losing no source light to absorption or scatter.

Most current optical sources, such as arc lamps, have a small near field extent and a large far field solid angle. Conversely, most current optical devices, such as micromirror-based spatial light modulators in display systems, require a large near field areal extent but a small far field solid angle. Specifically for a display system using a spatial light modulator, a more ideal condenser design will enable the system having the spatial light modulator of a given area and numerical aperture to deliver more total light to the screen. Additionally, the increased phase space density of a better condenser enables greater latitude in design tradeoffs when optimizing the system components, such as color wheel, spatial light modulator, and projection lens.

Current condenser designs for arc lamps employ imaging optical elements such as revolution elliptical or paraboloid reflectors to re-image parts of the source such that the far field solid angle is reduced to less than 2π steradians. Re-imaging sources of large far field solid angles is fraught with aberrations that sparsely fill the phase space. Moreover, re-imaging of large solid angle lose light by re-imaging some of the source rays back into the source. Thus imaging concentrators (e.g. reflector in arc lamp) suffer from losing some of the source rays and delivering an output occupying greater phase space volume than the source.

As a way of example, FIG. 1A schematically illustrates a cross-sectional view of an imaging arc lamp in prior art. The arc lamp comprises arc cylinder 104 and paraboloid reflector 102. The arc cylinder emanates light in all directions. A portion of the light from the arc cylinder is collected by the reflector and reflected towards a focus of the paraboloid. This type of arc lamp condenser is optically inefficient due to the fact that its output intensity profile 108 presents a “donut hole” around the axis of the arc cylinder, which in turn results in sparsely filled phase space spanned by the near field illumination area and far field solid angle. The “donut hole” corresponds to the re-imaging phenomenon in which the light collected by the zone AB of the paraboloid reflector is reflected back onto the arc cylinder or blocked by electrodes. The “donut hole” and the sparsely filled output phase space are intrinsic to the arc lamp condenser in FIG. 1A, which cannot be solved by configuration of the arc lamp components.

The dilemma of unfilled phase space and the dilemma of source rays being re-imaged onto the source can be solved by non-imaging optics. However, existing non-imaging reflector designs for cylindrical sources bring the reflective surfaces into contact with the source, precluding their application to thermal sources.

FIG. 1B schematically illustrates a non-imaging condenser in prior art which has a fulfilled phase space. Different from the reflector in FIG. 1A, reflector 110 in FIG. 1B consists of two intersected segments, each of which is a paraboloid. The two segments form a vertex that contacts the source cylinder. In this condenser, the light collected by the reflector is reflected towards a focus of the reflector and no light collected by the reflector is reflected back into the source cylinder. Accordingly, the output intensity profile is fully filled and has no “donut hole” presented in the output of the condenser in FIG. 1A. Because the reflector is in contact with the source cylinder via the vertex, this condenser, while suitable for a fluorescent lamp, cannot be applied to thermal sources such as arc lamps. The highest brightness white light sources commercially available are thermal sources such as arc lamps. The illumination intensity and the brightness of thermal sources, however, are proportional to the fourth power of source temperature. The source and condenser in FIG. 1B is therefore limited to applications of low illumination intensity and low brightness as compared to condensers where the reflector is spaced apart from the source.

A straight forward modification of the condenser in FIG. 1B is to separate the reflector surface from contacting the surface of the arc cylinder as illustrated in FIG. 1C. This configuration enables application of the condenser to thermal sources thus yielding a higher illumination intensity and brightness than that in FIG. 1B. However, the gap between the reflector and the arc cylinder causes a donut hole in the illumination intensity profile 120 as shown in the figure, resulting in sparsely filled phase space at the condenser output.

Therefore, what is desired is an illumination system having improved optical efficiency and wide spread utilizations in optical systems.

### SUMMARY OF THE INVENTION

In view of the foregoing, the present invention provides an illumination system particularly useful in display system, such as display systems employing micromirror-based spatial light modulators. The illumination system comprises a light source, in which an arc cylinder is positioned within a reflector composed of a plurality of reflective surfaces at least one of which is spiral in shape. Such objects of the invention are achieved in the features of the independent claims attached hereto. Preferred embodiments are characterized in the dependent claims.

### BRIEF DESCRIPTION OF DRAWINGS

While the appended claims set forth the features of the present invention with particularity, the invention, together with its objects and advantages, may be best understood from the following detailed description taken in conjunction with the accompanying drawings of which:

FIG. 1A illustrates an imaging arc lamp condenser in prior art;

FIG. 1B illustrates a non-imaging condenser in prior art;

FIG. 1C illustrates another non-imaging condenser in prior art;

FIG. 2 illustrates an arc lamp with condenser in the present invention;

FIG. 3A illustrates contour projections of the reflector surface from the condenser of FIG. 2 in the X-Y plane;

FIG. 3B illustrates contours of the condenser reflector surface of FIG. 2 along Z direction;

FIG. 4 illustrates reflection of the light by the spiral quadrants within the cavity of the arc lamp;

FIG. 5 illustrates the reflection of the rays by a counter-clockwise spiral quadrant;

FIG. 6 illustrates the reflection of the rays by another counter-clockwise spiral quadrant;

FIG. 7 illustrates the reflection of the rays by a clockwise spiral quadrant;

FIG. 8 illustrates the reflection of the rays by another clockwise spiral quadrant;

FIG. 9 illustrates the reflection of the rays by the two counter-clockwise quadrants, wherein the rays are tangent to the surface of the arc cylinder and perpendicular to the surface of counter-clockwise quadrant;

FIG. 10 illustrates the reflection of external rays entering into the cavity from outside of the exiting light cone;

FIG. 11A is a perspective view of an arc cylinder;

FIG. 11B is a cross-section of the arc cylinder in FIG. 11A;

FIG. 12A is a perspective view of a virtual arc cylinder;

FIG. 12B is a cross-section of the virtual arc cylinder in FIG. 12A;

FIG. 13 schematically illustrates the exiting light cone of the arc lamp;

FIG. 14A illustrates a top view of the arc lamp connected to a light pipe with tapered walls;

FIG. 14B illustrates a side view of the arc lamp of connected to the light pipe with tapered walls;

FIG. 15 is a cross-sectional view of an arc lamp of the present invention wherein the arc cylinder is positioned inside the arc cylinder;

FIG. 16 is a cross-sectional view of another arc lamp of the present invention wherein the arc cylinder is positioned outside the arc cylinder;

FIG. 17a through 17d are diagrams illustrating exemplary display systems employing arc lamps of the present invention for illuminating the spatial light modulators therein;

FIG. 18 is a perspective view of the spatial light modulator in FIGS. 17a through 17d, wherein the spatial light modulator comprises an array of micromirrors for modulating the light from the arc lamp;

FIG. 19 schematically illustrates light traces in an exemplary reflector of the invention;

FIG. 20 schematically illustrates light traces in another exemplary reflector of the invention;

FIG. 21 illustrates another exemplary illumination system; and

FIG. 22 plots the angle vs. position of a set of uniform source rays.

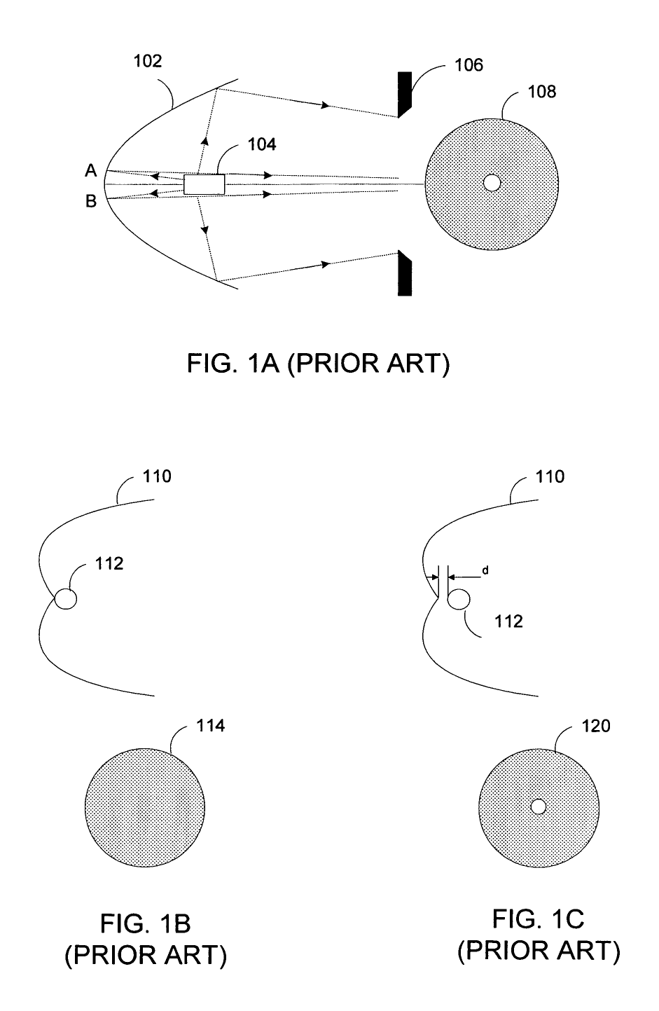

### DETAILED DESCRIPTION OF THE INVENTION

The present invention provides an illumination system having a condenser and a light source with improved optical efficiency. The condenser transforms the far field solid angle and the near field illumination area of the source to provide an output such that the volume of the four dimensional phase space spanned by the far field solid angle and near field illumination area is conserved from the source to the condenser output. The energy, released from the arc lamp source, is conserved by directing no light back into the source. In particular, the phase space of the arc lamp is densely filled, as is condenser output phase space. The near field pattern (the pattern of irradiance on the surface of the source) emerging from the aperture of the arc lamp appears to emanate from a virtual arc source of a larger surface area than the real arc source. The solid angle illuminated in the far field is densely packed and sub-hemispherical. For example, the far field half angle with respect to the plane perpendicular to the axis of the arc cylinder is 20° degrees or higher, or 30° degrees or higher, whereas the far field half angle with respect to the plane parallel to the axis of the arc cylinder is 10 degrees or less, which benefits the optical coupling of the arc lamp with other optical devices, such as a light pipe. This is of particular importance when the arc lamp is used as a light source for illuminating a spatial light modulator that has a small size (e.g. 1 inch or less, or 0.7 inch or less) and operates between ON and OFF state angles, wherein the difference between the ON and OFF states is small (e.g. from 12° degrees to 30° degrees). Moreover, the output solid angle can be adjusted as desired through varying the ratio of the dimension of the cavity formed by the reflector and the dimension (e.g. the diameter of the arc cylinder) of the arc source.

As an example, an arc lamp of the present invention comprises an arc source for emitting light and a reflector for collecting and reflecting the light. All parts of the reflector surface are substantially equidistant from the surface of the arc source, which enables the reflector to operate with an arc lamp or any other thermal source. Design of the reflector encompasses both the edge ray principle from the field of non-imaging optics and the astable resonator theory.

The reflector of the arc lamp may be composed of quadrants from different groups of quadrants, wherein the quadrants in different groups have different reflection properties. The surface quadrants of the preferred embodiment, as viewed in any latitude planar slice normal to the arc cylinder axis (z axis), are spiral curves. The spirals in quadrants 1 and 3 expand in a counter clockwise fashion while the spirals in quadrants 2 and 4 expand in a clockwise fashion. The exit aperture in the reflector surface is placed at the boundary between quadrants 1 and 4, making the +X direction the direction of light output. The reflector has an equatorial plane of mirror symmetry at Z=0 which bifurcates both the source cylinder and exit aperture. A second plane of mirror symmetry, at Y=0, also bifurcates the source cylinder and exit aperture. The latitude planar slices of the clockwise spiral quadrants are defined as curves normal to counter clockwise pointing tangents from the source cylinder surface. The latitude planar slices of the counter clockwise spiral quadrants are defined as curves normal to clockwise pointing tangents from the source cylinder surface. Tangential light rays emanating clockwise from the source's cylindrical surface, which strike a counter clockwise spiral quadrant, are reflected back into that same tangential plane and skim counter clockwise back by the source surface. Tangential light rays emanating counter clockwise from the source's cylindrical surface, which strike a clockwise spiral quadrant, are also reflected back into that same tangential plane and skim clockwise back by the source surface.

Source rays, which strike clockwise reflector quadrants, will bounce between the two clockwise spirals while circulating about the source in a clockwise fashion. These clockwise circulating rays successively intercept the clockwise spirals at points which process counter clockwise towards the exit aperture. Similarly, Source rays, which strike counter clockwise reflector quadrants, will bounce between the two counter clockwise spirals while circulating about the source in a counter clockwise fashion. These counter clockwise circulating rays successively intercept the counter clockwise spirals at points which process clockwise towards the exit aperture. Thus light rays will tend to circulate both clockwise and counter clockwise about the source cylinder while evolving towards larger separations from the cylinder (Z) axis, but towards smaller angles with respect to the Y=0 plane of mirror symmetry. The light rays eventually exit at the exit aperture, and are not sent back to the source.

The result is a light source which outputs light through the exit aperture along the +X direction. The output appears to emanate from a virtual source with enlarged near field extant in the Y direction, but diminished angular spread with respect to the Y=0 plane. The z direction near field extant, and far field angular extant about the Z=0 (equatorial) plane, are substantially similar to the source alone, and are limited by the arc lamp electrodes.

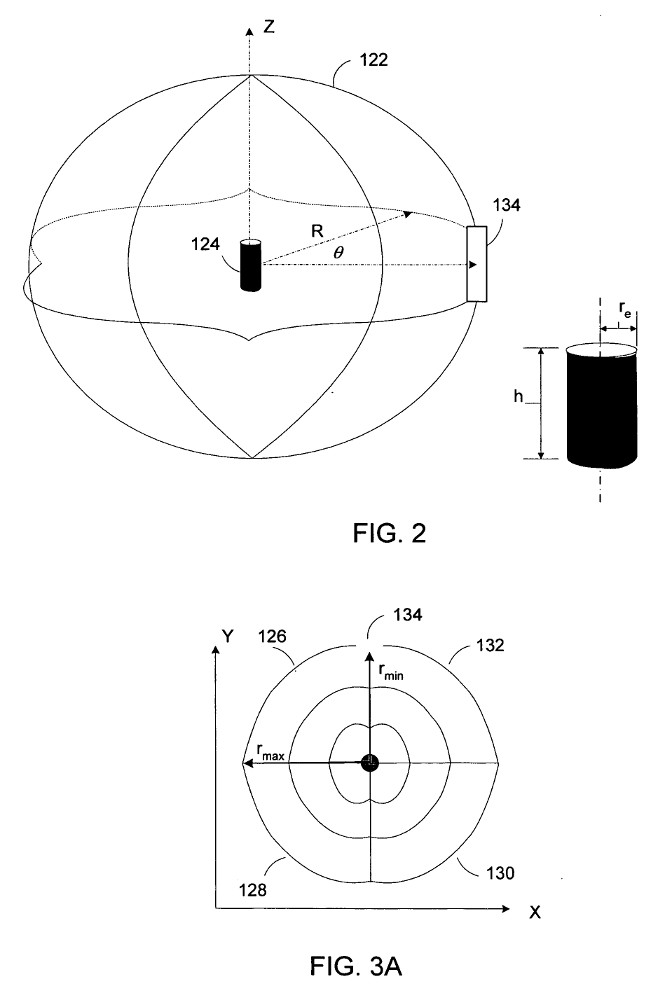

Turning to the drawings, FIG. 2 is a diagram that schematically illustrates a perspective view of an arc lamp in the invention. The arc lamp comprises arc source 124 and reflector 122. The arc source in this example is a cylinder positioned at the center of a cavity formed by the reflector. The reflector consists of four spiral quadrants 126, 128, 130, and 132. The quadrants are interconnected and positioned such that the inner surfaces of the quadrants are substantially equidistance from the center of the cavity. Aperture 134 can be placed at either intersection of the quadrants such that the light from the arc cylinder can escape from the cavity through the aperture perpendicularly to the length of the arc cylinder. It can be seen from the figure that, the reflector has three two-folded symmetry planes. Specifically, the reflector is symmetric with reference to θ=nπ/2 (n is an integer) planes and z=0 plane. Further more, the reflector is symmetric to the arc cylinder. The shape of the spiral quadrant can be described by the following equations in the cylindrical coordinate.

Definition of the Parameters

re: radius of the arc cylinder;

h: height of the arc cylinder;

rₘᵢₙ(z): minimum radius of the contour at position z;

rₘₐₓ(z): maximum radius of the contour at position z;

rᵥ: minimum radius of the equator at z=0;

w: width of the aperture; and

l: length of the aperture.

Of these parameters, rₑ, h and rᵥ are independent variables and can be adjusted so as to obtain desired optical properties. For example, the ratio of the minimum radius rᵥ of the equator at z=0 and radius re of the arc cylinder can be used to adjust the near field solid angle of the arc lamp. The minimum radius of the equator at z=0 rᵥ can be 5 times or more, or 10 times or more, or 20 times or more of the radius of the arc cylinder. The dimension (w or l) of the aperture is preferably larger than the dimension of the arc cylinder. In particular, the area (product of the length and width) of the aperture can be around 30% or less, or 20% or less, or 10% or less, or 5% or less, or 1% or less of the surface area of the cavity formed by the quadrants. That is, the quadrants cover 70% or more, or 80% or more, or 90% or more, 95% or more, or 99% or more of the surface area of the cavity. This requires that the surface shape of the reflector is not monotonic. For example, the slope of the intersection curve of Y-Z plane to the reflector has both positive and negative values. Rather than a rectangular slit, the aperture can take any desired forms, such as a circular opening or any other shapes.

As an example of the invention, the spiral quadrants can be described by the following equations.

At position z, rₘᵢₙ(z) can be calculated as:

$${r}_{min} ( z ) = {r}_{v} \sqrt{1 - \frac{4 {z}^{2}}{4 {r}_{v}^{2} + {h}^{2}}} , wherein \vert z \vert \leq \sqrt{( 1 + \frac{{h}^{2}}{4 {r}_{v}^{2}} ) ( {r}_{v}^{2} - {r}_{e}^{2} )} \qquad Eq . 1$$

rₘₐₓ(z) can be iteratively calculated from equation:

$$\sqrt{\frac{{r}_{max}^{2} ( z )}{{r}_{e}^{2}} - 1} - arccos \frac{{r}_{e}}{{r}_{max} ( z )} = \frac{π}{2} + \sqrt{\frac{{r}_{min}^{2} ( z )}{{r}_{e}^{2}} - 1} - arccos \frac{{r}_{e}}{{r}_{min} ( z )} , \\ wherein \\ \vert z \vert \leq \sqrt{( 1 + \frac{{h}^{2}}{4 {r}_{v}^{2}} ) ( {r}_{v}^{2} - {r}_{e}^{2} )} \qquad Eq . 2$$

The first quadrant (e.g. quadrant 132 in FIG. 2) can be expressed as:

$$\begin{matrix}θ = \sqrt{\frac{{r}^{2}}{{r}_{e}^{2}} - 1} - \sqrt{\frac{{r}_{min}^{2} ( z )}{{r}_{e}^{2}} - 1} - arccos ( \frac{{r}_{e}}{r} ) + arccos ( \frac{{r}_{e}}{{r}_{min} ( z )} ) , \\ wherein \\ {r}_{min} ( z ) \leq r \leq {r}_{max} ( z )\end{matrix} \qquad Eq . 3$$

The second quadrant (e.g. quadrant 126 in FIG. 2) can be expressed as:

$$\begin{matrix}θ = π - \sqrt{\frac{{r}^{2}}{{r}_{e}^{2}} - 1} + \sqrt{\frac{{r}_{min}^{2} ( z )}{{r}_{e}^{2}} - 1} + arccos ( \frac{{r}_{e}}{r} ) - arccos ( \frac{{r}_{e}}{{r}_{min} ( z )} ) , \\ wherein \\ {r}_{min} ( z ) \leq r \leq {r}_{max} ( z )\end{matrix} \qquad Eq . 4$$

The third quadrant (e.g. quadrant 128 in FIG. 2) can be expressed as:

$$\begin{matrix}θ = - π + \sqrt{\frac{{r}^{2}}{{r}_{e}^{2}} - 1} - \sqrt{\frac{{r}_{min}^{2} ( z )}{{r}_{e}^{2}} - 1} - arccos ( \frac{{r}_{e}}{r} ) + arccos ( \frac{{r}_{e}}{{r}_{min} ( z )} ) , \\ wherein \\ {r}_{min} ( z ) \leq r \leq {r}_{max} ( z )\end{matrix} \qquad Eq . 5$$

The fourth quadrant (e.g. quadrant 130 in FIG. 2) can be expressed as:

$$\begin{matrix}θ = - \sqrt{\frac{{r}^{2}}{{r}_{e}^{2}} - 1} + \sqrt{\frac{{r}_{min}^{2} ( z )}{{r}_{e}^{2}} - 1} + arccos ( \frac{{r}_{e}}{r} ) - arccos ( \frac{{r}_{e}}{{r}_{min} ( z )} ) , \\ wherein \\ {r}_{min} ( z ) \leq r \leq {r}_{max} ( z )\end{matrix} \qquad Eq . 6$$

Derivation of these equations is presented in appendix A of this application and will not be discussed in detail herein.

For better illustrating the geometric configuration of the quadrants, X-Y plane projections of the contours of these quadrants at different z-values are illustrated in FIG. 3A. The outmost circle is the equator (z=0) of the reflector in the X-Y plane; and the inner circles are contours of the reflector at different non-zero z positions. The circles shrink and converge to z axis with increasing z vales. Each circle of the contour comprises four spirals curves corresponding to the four spiral quadrants. The spirals are interconnected sequentially according to a particular pattern. Specifically, spirals 132 and 126 are connected at their parts having the minimum distances to the arc cylinder such that the intersection of the spirals forms a concave pointing towards the arc cylinder. Aperture 134 can be positioned around the concave. Spirals 126 and 128 are interconnected through their parts having the maximum distances from the arc cylinder such that intersect of the two spirals forms a convex pointing outwards from the cavity. Spiral 130 is connected to spiral 132 in the same as spiral 126 being connected to spiral 128. As a result, intersect of spirals 130 and 132 forms a convex pointing outwards from the cavity, and intersect of spirals 130 and 128 forms a concave pointing towards the arc cylinder.

The above description describes one way to construct the 3-dimensional reflector. Another possible embodiment would be to use the curve described above with Z=0, and revolve this about the Y axis to form a 3-dimensional cavity.

The spirals of the quadrants at different z values are also shown in the figure. As can be seen, the curvature of each spiral decreases with increasing z value—causing the spirals to converge at Z-axis. Projections of the contours in the X-Z plane of the quadrants are illustrated in FIG. 3B.

In the above discussion, the reflector of the arc lamp consists of four quadrants with spiral surfaces that are interconnected according to the particular pattern. In another example, the reflector comprises multiple spiral surfaces, at least one of which is not a quadrant. Specifically, at least one of the spiral surfaces covers more than a quarter of the cavity—that is, at least one of the spiral surfaces covers less than a quarter of the cavity. In fact, the surfaces of the reflector may take a spiral form other than those described in equations 1 to 6. For example, the reflector consists of multiple surface segments, at least one of which is a spiral surface defined by equations 1 to 6; whereas the other surface segments are other type of spirals surfaces, such as Archimedean's spirals, circle involute spirals, clothoid spirals, concho-spirals, concho-spirals, continuous-line-illusion spirals, cornu-spirals, Cotes' spirals, Fermat's spirals, Fermat's spiral inverse curves, hyperbolic spirals, hyperbolic spiral inverses, hyperbolic spiral roulette curves, lituus spirals, lituus inverse curves, logarithmic spirals, logarithmic spiral catacaustic curves, logarithmic spiral evolutes curves, logarithmic spiral pedal curves, logarithmic spiral radial spirals, mice problem spirals, Nielsen's spirals, Phyllotaxis spirals, Poinsot's spirals, polygonal spirals, prime spirals, rational spirals, Seiffert's spherical spirals, sici spirals, sinusoidal spirals, sinusoidal spiral inverse spirals, sinusoidal spiral pedal curves, spherical spirals, or whirls. The other surface segments may also take a form that is not a spiral, such as an algebraic surface (e.g. quadric) and revolution surface (e.g. spherical surface and spheroid surface). As another embodiment of the present invention, the surface of the reflector is such a surface that at most one component of a line that connecting a point of the surface and a point at the edge of the arc cylinder is perpendicular to the surface of the reflector.

In the following, operation of the reflector will be discussed with reference to examples in which the reflector comprises four spiral quadrants as shown in FIGS. 2, 3A and 3B. Those skilled in the art will certainly appreciate that the following discussion is for demonstration purposes only. Other variations without departing from the spirit of the present invention are not to be excluded from the following discussions.

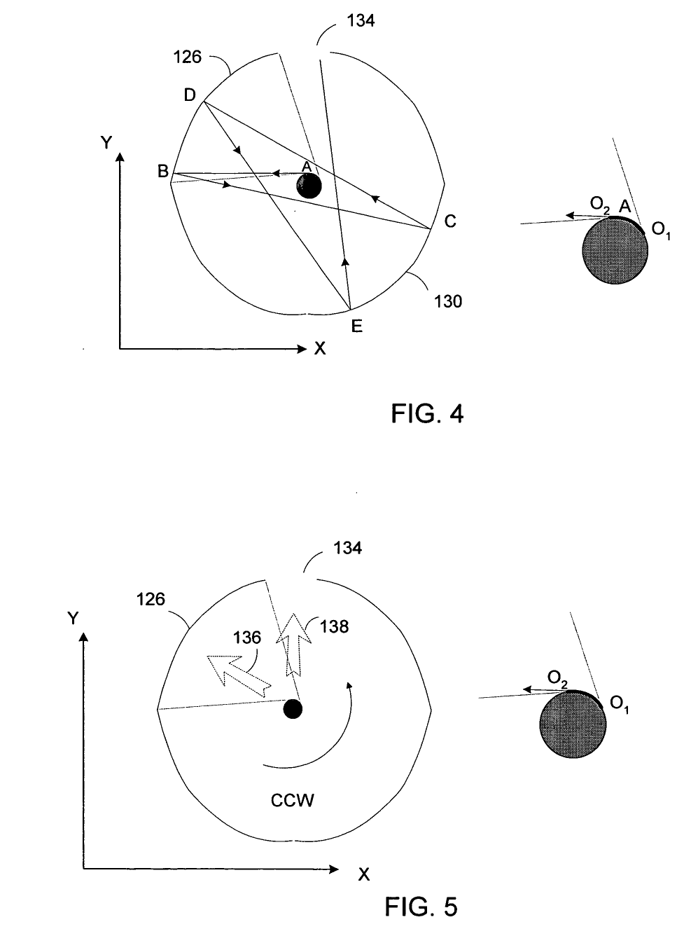

Referring to FIG. 4, a ray emanated from point A on the edge of the arc cylinder hits point B at quadrant 126. Because of the spiral nature of quadrant 126 and relative positions of the arc cylinder and the quadrant, the ray impinges the quadrant at a non-zero angle to the surface of the quadrant. The spiral quadrant reflects the collected ray to point C in quadrant 130 such that the reflected ray from points B to C does not hit the arc cylinder. After quadrant 130, the ray may experience higher order reflections between quadrants 126 and 130 before escaping the cavity from aperture 134. For example, the ray from point C at quadrant 130 is reflected to point D at quadrant 126 that further reflects the ray from point D to point E at quadrant 130. The ray from point E at quadrant 130 then escapes the cavity from the aperture. In general, the closer the ray emanated from the arc cylinder to the convex of the adjacent quadrants, the higher order reflection the ray experiences. A ray emanated from the arc cylinder close to the aperture may escape the cavity after reflection by quadrant 130 only once. It can be seen that, the ray emanated from point A at the arc cylinder to quadrant 126 progresses counter-clockwise about the arc cylinder and converges to the aperture under the reflection of quadrant 126.

According to the edge ray theory, all rays emanated from the points in the section from O₁ to O₂ on the edge of the arc cylinder are collected by quadrant 126 and reflected in the same way as the ray from point A to point B, wherein O₁ is the tangent point of the tangent line passing through the edge of the aperture; and O₂ is the tangent point of the tangent line passing through the convex of quadrants 126 and 128.

Reflection of quadrant 126 to the rays from the section O₁O₂ in the arc cylinder can be summarized in FIG. 5. Referring to FIG. 5, rays 136 from section O₁O₂ hit quadrant 126 and revolve counter-clockwise about the arc cylinder into rays 138 pointing towards the aperture, from which the rays escape from the cavity. During the reflection and evolution, none of the rays emanated from O₁O₂ section in the arc cylinder is directed to the arc cylinder. Instead, all rays emanated from section O₁O₂ escape from the cavity. Because quadrant 126 collects and reflects the rays such that the rays progress counter-clockwise about the arc cylinder, quadrant 126 is referred to as counter-clockwise spiral quadrant.

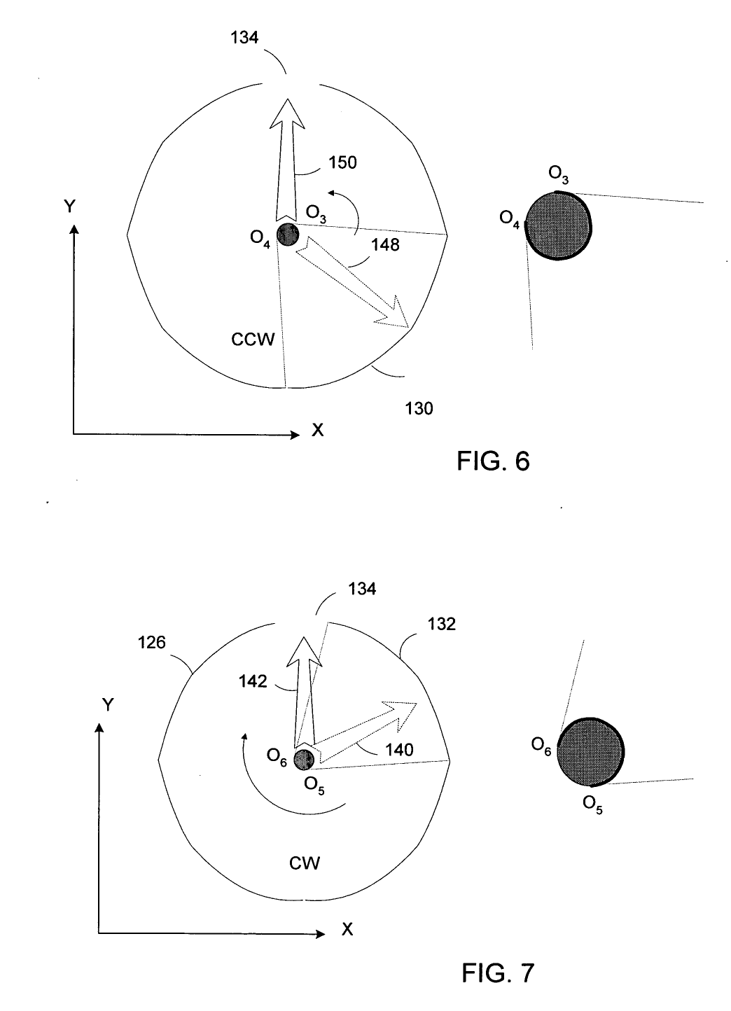

The same as quadrant 126, quadrant 130 is a counter-clockwise spiral quadrant, as shown in FIG. 6. That is, rays 148 emanated from the points in the section from O₃ to O₄ on the edge of the arc cylinder are collected and reflected by quadrant 130, wherein O₃ is the tangent point of the tangent line passing through the convex of quadrants 132 and 130; and O₄ is the tangent point of the tangent line passing through the concave of quadrants 130 and 128. Rays 148 from section O₃O₄ hit quadrant 130 and revolve counter-clockwise about the arc cylinder into rays 150 pointing towards the aperture, form which the rays escape from the cavity. During the reflection and evolution, none of the rays emanated from O₃O₄ section in the arc cylinder is directed to the arc cylinder. Instead, all rays emanated from section O₃O₄ escape from the cavity.

As opposed to counter-clockwise spiral quadrants 126 and 130, quadrants 132 is a clockwise quadrant, as shown in FIG. 7. Specifically, rays 140 emanated from the points in the section from O₅ to O₆ on the edge of the arc cylinder are collected and reflected by quadrant 132, wherein O₅ is the tangent point of the tangent line passing through the convex of quadrants 132 and 128; and O₆ is the tangent point of the tangent line passing through the edge of the aperture. Rays 140 from section O₅O₆ hit quadrant 132 and revolve clockwise about the arc cylinder into rays 142 pointing towards the aperture, form which the rays escape from the cavity. During the reflection and evolution, none of the rays emanated from O₅O₆ section in the arc cylinder is directed to the arc cylinder. Instead, all rays emanated from section O₅O₆ escape from the cavity.

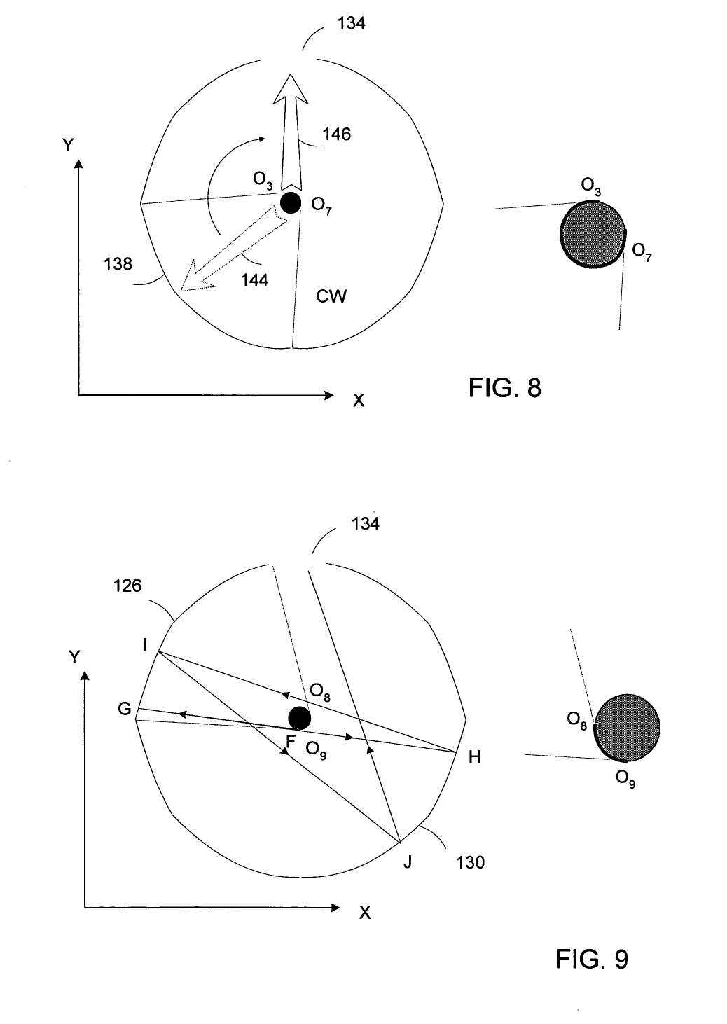

Referring to FIG. 8, quadrant 138 is a clockwise spiral quadrant, which collects and reflects rays 144 from the points in section O₃O₇ on the edge of the arc cylinder, wherein O₇ is the tangent point of the tangent line passing through the concave of quadrants 138 and 140. Rays 144 from section O₃O₇ hit quadrant 138 and revolve clockwise about the arc cylinder into rays 146 pointing towards the aperture, form which the rays escape from the cavity. During the reflection and evolution, none of the rays emanated from O₃O₇ section in the arc cylinder is directed to the arc cylinder. Instead, all rays emanated from section O₃O₇ escape from the cavity.

It can be seen from the FIGS. 5 to 8, the reflector comprises four quadrants of different reflection properties. Two of the four quadrants are clockwise spiral quadrants and the other two are counter-clockwise quadrants. Quadrants of different reflection properties are positioned alternatively around the cavity such that rays are reflected between quadrants of the same reflection properties. Specifically, a clockwise spiral quadrant is positioned between and connected to two counter-clockwise spiral quadrants. A counter-clockwise spiral quadrant is positioned between and connected to two clockwise spiral quadrants. The aperture from which the rays escape from the cavity is placed at the concave of two adjacent quadrants. The aperture has at least one dimension larger than the length of the arc cylinder; and the aperture is positioned such that the larger dimension is perpendicular to the length of the arc cylinder.

In the above discussion with reference to FIGS. 4 to 8, rays from the arc cylinder hit the spiral surfaces with non-zero incident angles in the X-Y plane. Because of the spiral nature of the quadrants, the rays in the X-Y plane revolve either clockwise or counter-clockwise as appropriate about the arc cylinder and converge to the aperture after reflections by the quadrants. The states of the rays in the X-Y plane within the cavity are referred to as astable state. Accordingly, the cavity is said to have an astable state in the X-Y plane. The cavity of the arc lamp in the present invention, however, may have astable state along z direction. Specifically, the z components of the rays in FIGS. 4 to 8 can be perpendicular to the quadrant surfaces. These z components are then mirrored back onto opposite quadrants of the same reflection property and may not escape from the aperture after reflections.

In addition to the rays that hit the quadrants at non-zero incident angles in the X-Y plane as shown in FIGS. 4 to 8, rays from the arc cylinder may impinge the spiral surfaces of the quadrants perpendicularly in the X-Y plane as shown in FIG. 9. Referring to FIG. 9, a ray emanated from point F on the edge of the arc cylinder hits point G at quadrant 126. The ray from F to G is perpendicular to the surface of quadrant 126 in the X-Y plane and tangent to the end of the arc cylinder at point F. Quadrant 126 then reflects the ray such that the path of the reflected ray from G to point H at spiral quadrant 130 coincides with the path of the ray from F to G in the X-Y plane. However, the reflected ray from G to H has a displacement in the Z direction relative to the ray from F to G. Spiral quadrant 130 reflects the ray from H to point I in quadrant 126. The reflected ray from H to I is displaced not only from the arc cylinder in the X-Y plane but also in Z direction. The ray originated from H to I is reflected to spiral quadrant 130 at point J and escapes the cavity from the aperture after reflection by spiral quadrant 130.

According to the edge ray theory, all rays emanated from the points in the section from O₈ to O₉ on the edge of the arc cylinder are collected by quadrant 126 and reflected in the same way as the ray from point F to point G, wherein O₈ is the tangent point of the tangent line passing through the edge of the aperture; and O₉ is the tangent point of the tangent line passing through the convex of quadrants 126 and 128. The same as rays 136 from section O₁O₂ in FIG. 5, the rays from the section O₈O₉ pointing at quadrant 126 revolve counter-clockwise about the arc cylinder and converge at the aperture. During the reflection and evolution, none of the rays emanated from O₈O₉ section in the arc cylinder is directed to the arc cylinder. Instead, all these rays escape from the cavity.

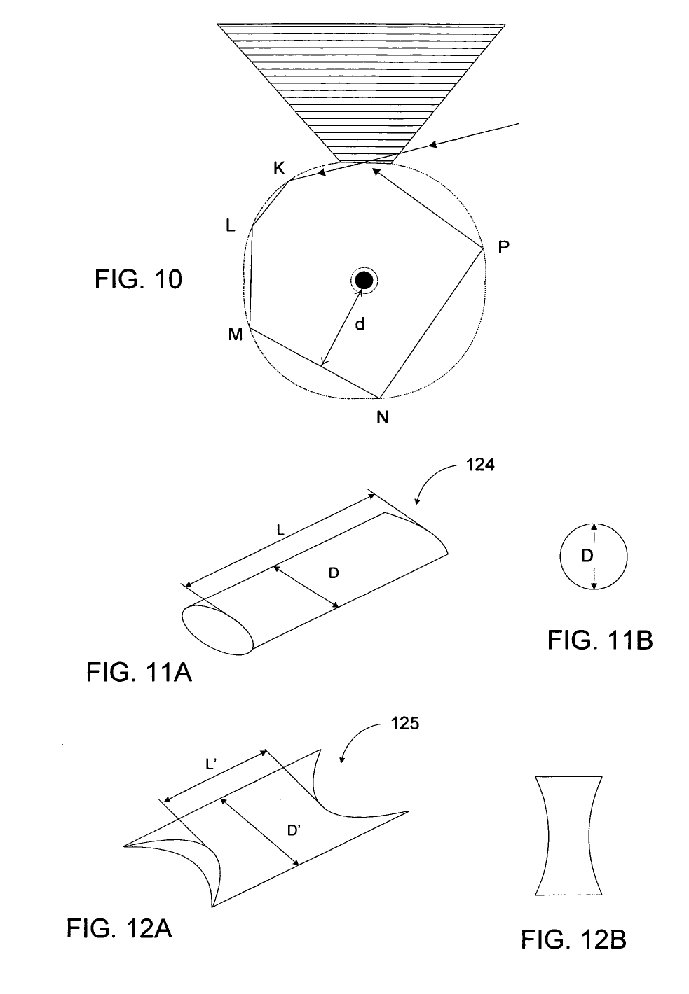

In addition to the rays emanated from the arc cylinder, external rays may enter into the cavity and reflected by the quadrants. The external ray may enter into the cavity from inside the exit light cone of the arc lamp as illustrated in the shaded area in FIG. 10. In this situation, the external ray is reflected by the quadrants and exit from the aperture after many reflections such that the rays exit from the cavity appears to be emanated from a virtual arc source at a location of the real arc cylinder, as shown in the dotted circle in the figure.

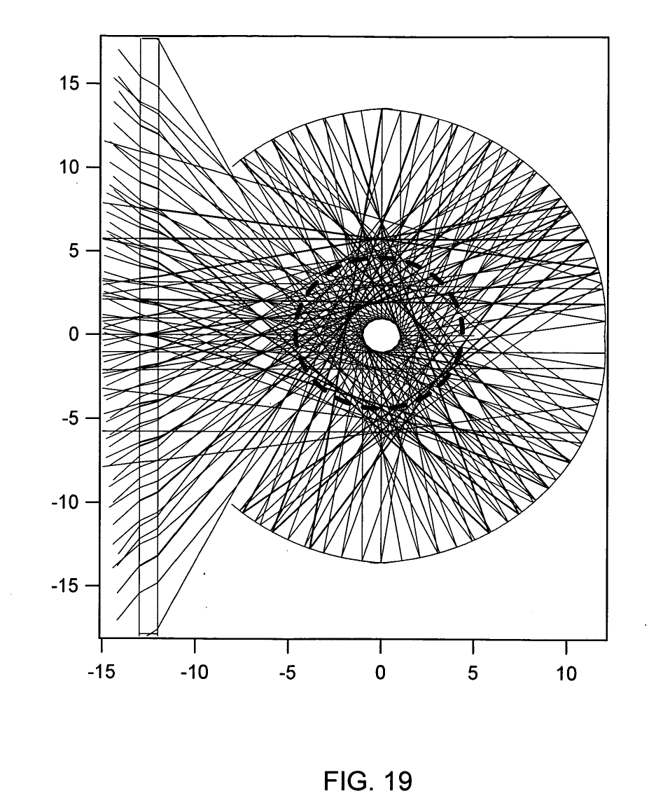

A light tracing diagram is illustrated in FIG. 19. Turning to FIG. 19, the imaginary arc cylinder is illustrated as the dashed circle. This imaginary arc cylinder is larger in size than the its real counterpart, but smaller than the interior space of the reflector. It is also seen in the figure that, no light within the reflector is bounced into the arc cylinder.

The external rays may enter into the cavity from outside the exit light cone of the arc lamp. As shown in FIG. 10, external rays enter into the cavity from outside the cone through the aperture and hits point K. The ray hit points L, M, N, and P consecutively under reflections by quadrants 126, 128, 130 and 132 respectively. Departing from quadrant 132, the rays escape the cavity through the aperture. These rays exiting from the arc lamp appears to be emanated form the cavity without an arc source, as opposed to the external rays entering into the cavity from inside the cone appears to be emanated from a virtual arc source.

The arc source of the arc lamp emanates omni-directional rays. The rays are then collected and reflected by the quadrants of the reflector. The rays eventually escape the cavity from the aperture after multiple reflections such that the rays appear to be emanated from a virtual arc source at the location of the real arc source but with a different shape, which will be discussed in detail in the following with reference to FIGS. 11A to 12B.

Referring to FIG. 11A, arc source 124 is an arc cylinder characterized by length L and diameter D. The arc cylinder is positioned at the center of the reflector cavity with the length along Z direction. FIG. 11B illustrates a cross-section of the arc cylinder, which is a circle with the diameter of D. Other than cylinder, the arc source can be of other shape, such as ecliptic cylinder.

FIG. 12A is a schematic diagram illustrating the virtual arc lamp from which the rays appear to be emanated. As compared to the real arc cylinder in FIG. 11A, the virtual arc cylinder is magnified in diameter, but shortened along the length. That is, the diameter D′ of the virtual arc cylinder is longer than the diameter of the real arc cylinder D. The length L′ of the virtual arc cylinder is shorter than the length L of the real arc cylinder. The cross-section of the virtual arc source is schematically illustrated in FIG. 12B.

The pattern of the virtual arc source as shown in FIGS. 12A and 12B is determined by the relative positions of the real arc cylinder and the aperture, wherein the length of the aperture is perpendicular to the length of the arc cylinder. In other configurations, the shape of the virtual arc source may change.

As discussed above, all rays emanated form the arc cylinder in all directions eventually escape the cavity from the aperture after multiple reflections by the spiral quadrants. Specifically, reflection of the rays in the X-Y plane proceeds following the astable state of the cavity; while reflection of the z components of the rays proceeds following the stable state of the cavity. Accordingly, the phase space spanned by two free variables of the far field solid angle and two free variables of the near field illumination area is densely filled. No far field “donut hole” or similar features of the prior art appear in the phase space of the arc lamp in the present invention. That is each unit area in the output illumination profile or the front surface of far field solid angle is illuminated. In terms of an optical transformation, the arc lamp of the present invention transforms the far field solid angle and near field illumination area such that the volume of the four dimensional phase space is conserved from the arc source of the arc lamp to the output of the arc lamp and also the input of the an optical device in connection with the arc lamp. Moreover, the energy (e.g. flux of photons) released from the arc source is also conserved by losing no light rays emanated from the arc source.

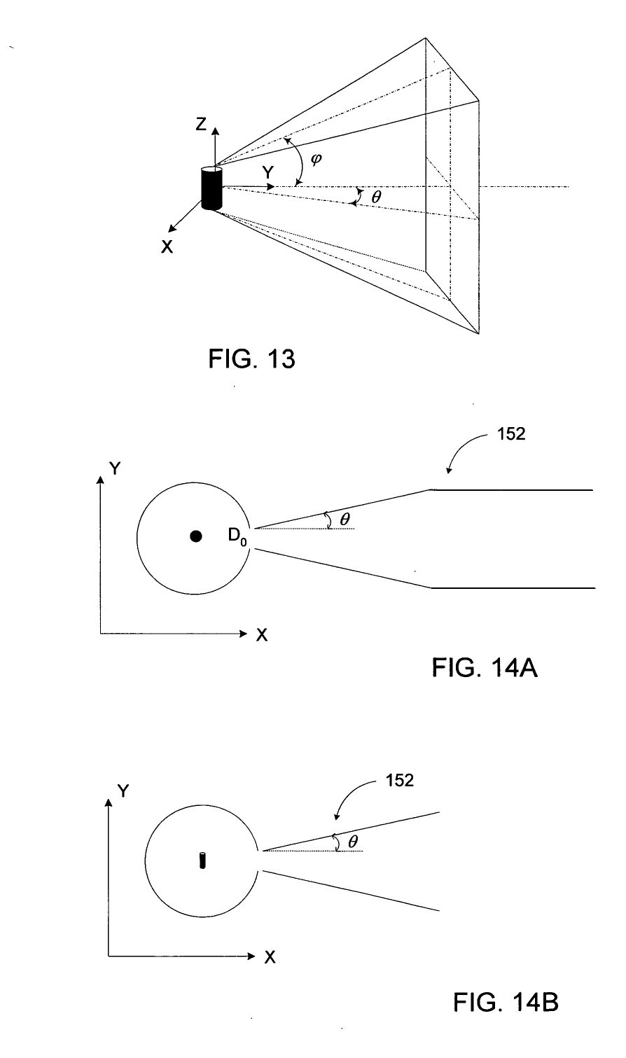

The rays exiting from the arc lamp in a light cone as schematically illustrated in FIG. 13. Angular variable θ measures the angular extent of the light cone in the X-Y plane; and angular variable φ measures the angular extend of the light cone along Z direction. Sinusoidal value of θ is defined as the numerical aperture of the arc lamp in the direction perpendicular to the length of the arc cylinder; and the sinusoidal value of φ is defined as the numerical aperture of the arc lamp in the direction parallel to the length of the arc cylinder. The values of θ and φ can be adjusted by varying the ratio of the cavity dimension and the diameter of the arc cylinder. As an example, the ratio of the cavity dimension to arc cylinder diameter can be 5 or more, or 10 or more, or 15 or more, or 20 or more, or 25 or more. Angle θ can be 20° degrees or less, or 15° degrees or less, or 10° or less, while angle φ can be 15° degrees or higher, or 20° degrees or higher, or 30° degrees or higher, or 50° degrees or higher. The light cone of these numerical values certainly benefits the optical coupling of the arc lamp with other optical devices, such as light pipe. In particular, these numerical aperture values improves the optical efficiency of a display system that uses the arc lamp as the light source for illuminating a spatial light modulator that operates between and ON and OFF angles, wherein the angular difference between the ON and OFF angles is small.

In application, a light pipe is often used for transforming the light from the arc lamp into desired optical devices, such as spatial light modulator. In an example of the invention, the aperture of the reflector has a dimension that is comparable to the input opening of the light pipe. For example, the ratio of the aperture and input opening dimensions is from 90% 120%. In this example, a light pipe with tapered walls is connected to the exit aperture of the arc lamp, as shown in FIGS. 14A and 14B. FIG. 14A is a schematic diagram illustrating a top view (viewed long the length of the arc cylinder) of light pipe 152 connected to the arc lamp. The tapered side wall (parallel to the Z axis) presents an angle α with X-axis. The value of angle α is comparable to angle θ—the angle of the light cone in the X-Y plane in FIG. 13.

FIG. 14B schematically illustrates the side view of the light pipe in connection with the arc lamp. The wall parallel to Y-axis presents an angle β with X-axis. The value of angle β is comparable to angle φ—the angle of the light cone along Z axis in FIG. 13.

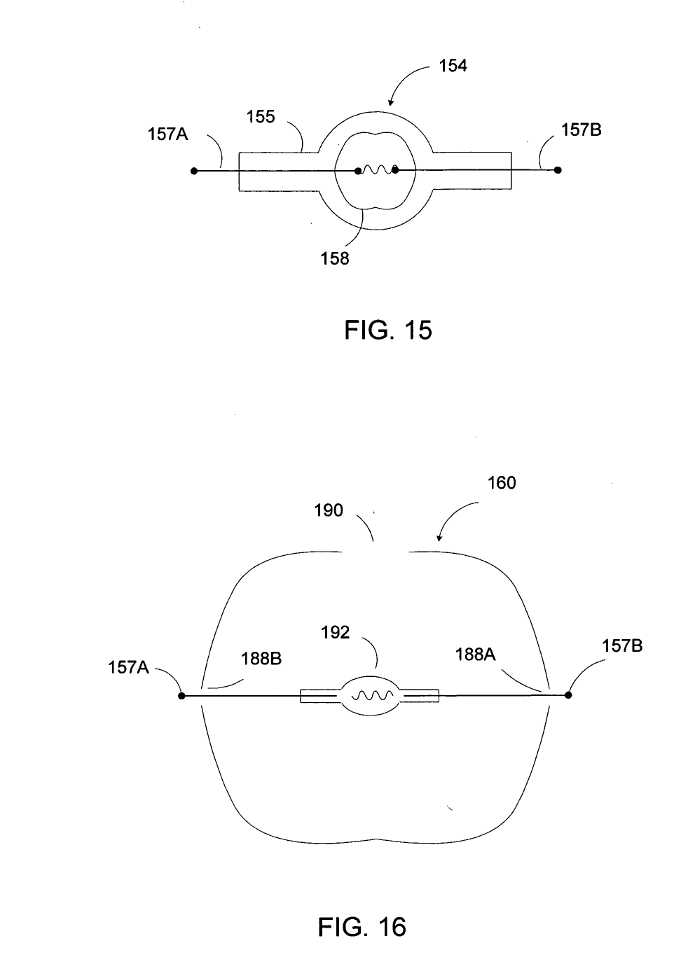

The reflector of the arc lamp in the present invention can be placed inside the arc assembly as shown in FIG. 15. Referring to FIG. 15, arc assembly 154 comprises arc tubing 155, in which electrodes 157A and 157B are disposed. Reflector having multiple quadrants is positioned inside the arc tubing and surrounding the electrodes from which light is emanated.

The reflector can also be placed outside the arc assembly as shown in FIG. 16. Arc assembly 192 is inserted into the cavity of reflector 160 from opening 157A or 157B located at the convexes of the reflector. Aperture 190 is opened at a concave between adjacent quadrants of the reflector.

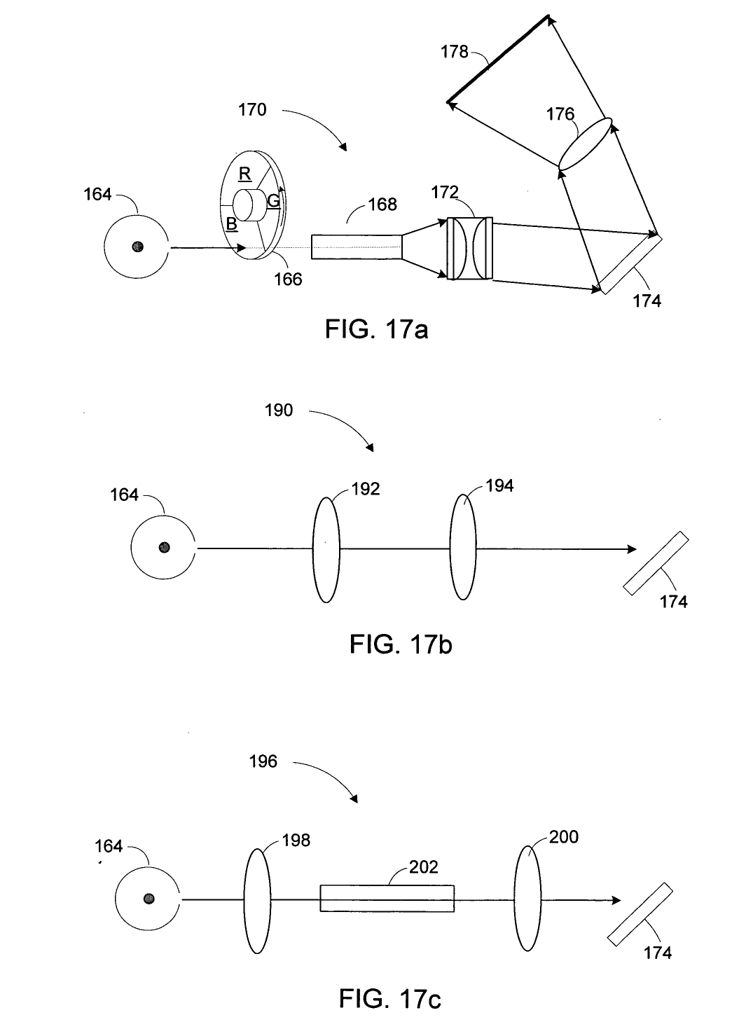

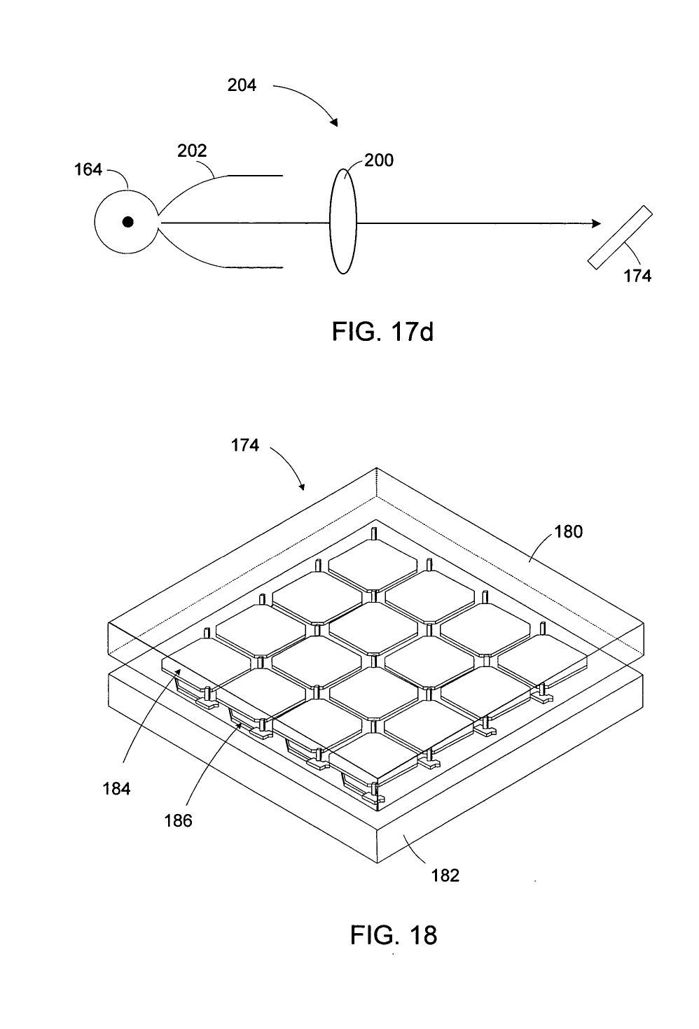

The arc lamp of the present invention is particularly useful in a display system employing a spatial light modulator that operates between an ON and OFF state angle. As an example, FIG. 17a schematically illustrates a display system that comprises arc lamp 164 and spatial light modulator 174. A portion of an exemplary spatial light modulator is illustrated in FIG. 18. Referring to FIG. 18, spatial light modulator 174 comprises an array of micromirrors 184 that is formed on glass substrate 180. The glass substrate is transmissive to visible light. The micromirrors are individually addressable by an array of electrodes 186 positioned proximate to the micromirrors. In operation, an electrostatic field is established between each mirror plate of the micromirror and an electrode associated with the micromirror. By adjusting the strength of the electrostatic field, the mirror plate rotates to either the ON or OFF state angle so as to reflect the incident light into different directions.

Turning back to FIG. 17a, light from arc lamp 164 of display system 170 is collected by light pipe 168 having tapered walls. Color wheel 166 can be placed between the arc lamp and the light pipe for generating color images. Alternatively, the color wheel can be placed after the light integrator at the propagation path of the illumination light from the light source. Light from the light pipe is focused onto the spatial light modulator by condensing lens 172. The light passes through the glass substrate (e.g. glass substrate 180 in FIG. 18) and shines on the mirror plates of the micromirrors that are set to the ON or OFF state according to the desired image. The light shining on the mirror plate at the ON state is collected by projection lens 176 and projected onto display target 178 so as to generate “bright” pixels on the display target. The light shining on the mirror plates at the OFF state is reflected away from the projection lens and creates dark pixels on the display target.

The display systems in which the arc lamps of the present invention may have other configurations, such as those simplified diagrams demonstrated in FIGS. 17b to 17d. Referring to FIG. 17b, a plurality of optical elements, such as lens 192 and 194 can be placed at the propagation path of the illumination light from arc lamp 164 between the arc lamp and spatial light modulator 174. These optical elements are provided for directing the illumination light from the light source onto the spatial light modulator, and for other purposes as appropriate, such as adjusting the spatial and/or angular distribution of the illumination light. Between the optical lens, such as lens 198 and 200 in FIG. 17c, light integrator 202 can be disposed. The light integrator can be provided especially for securing a uniform angular distribution, and/or the wave-front of the illumination light. In accordance with yet another embodiment of the invention, an additional reflector 202 is attached to the exit aperture of arc lamp 164. Such additional reflector may have the property of adjusting the angular distribution, and/or spatial distribution, including the profile of the wave-front of the illumination light. At the propagation path of the illumination light towards spatial light modulator 174, other optical elements, such as condensing lens 200, or a light integrator can be provided, but may not be necessary. The optical elements may comprise anamorphic lenses or anamorphic reflectors.

In general, the difference between the ON and OFF state angles of the micromirrors and other type of spatial light modulators is within a small range, such as from 10° to 30° degrees. This small angle difference raises stringent requirement on the solid angle of the cone of the incident light to obtain high contrast ratio and brightness of the displayed images. Specifically, the ON and OFF state angles are optimized to trade off between the brightness (which is determined by the optical through put of the display system) and contrast ratio, and between the illumination area (equivalent to the illumination area of the spatial light modulator) and the numerical aperture of the arc lamp. Both of the contrast ratio and brightness can be improved when the solid angle of the incident light cone is small.

As discussed earlier, the solid angle of the light cone exiting the arc lamp can be adjusted through the ratio of the dimensions of the cavity and the arc cylinder and can be made small, such as 20° degrees or less, or 15° degrees or less, or 10° or less in the direction perpendicular to the length of the arc cylinder. This small and adjustable angle certainly improves the tradeoffs between the optical through put and contrast ratio; and between the illumination area and numerical aperture of the arc lamp. Trading smaller numerical aperture for larger illumination area results in improved dielectric filter design and performance at the expense of longer transition time between colors or larger size of the color wheel.

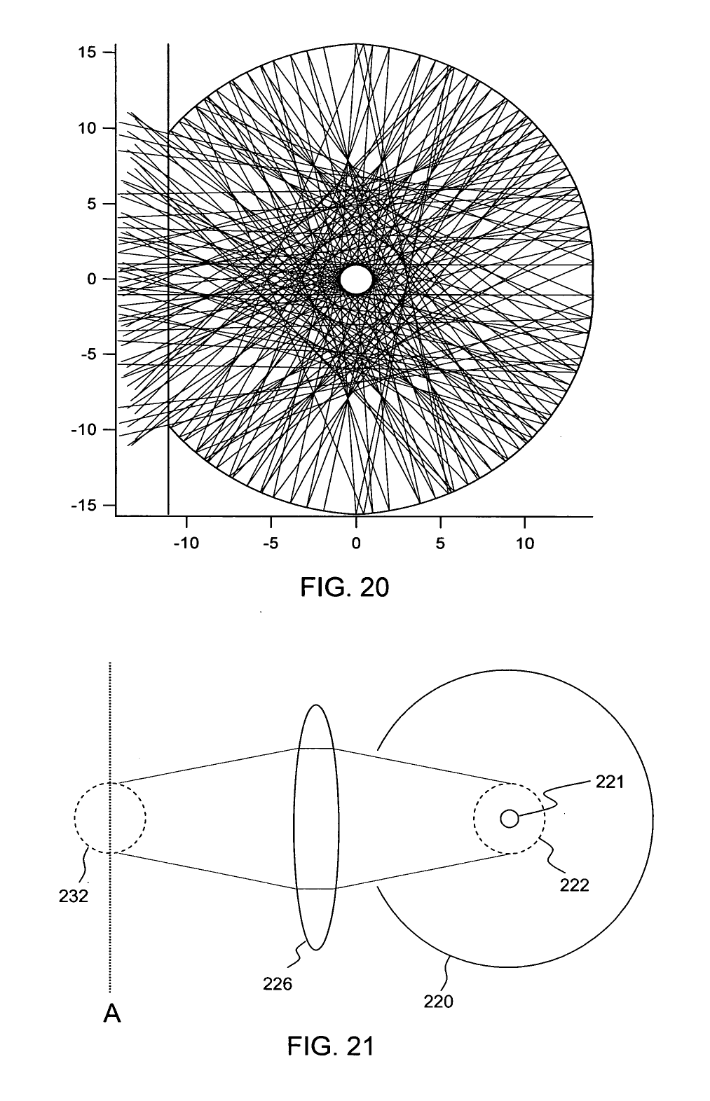

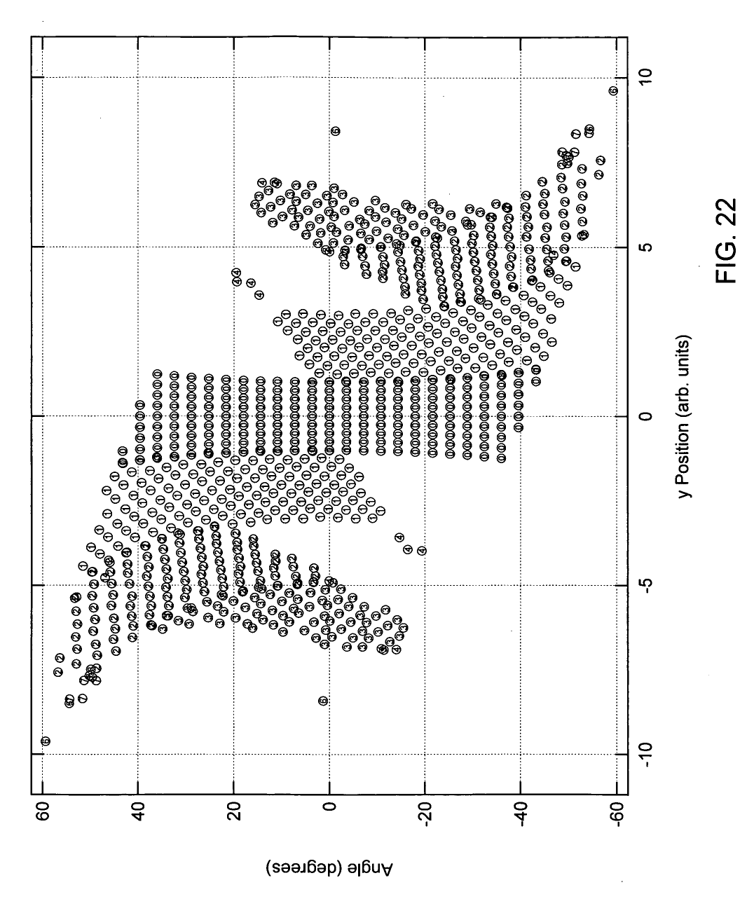

FIG. 20 illustrates another exemplary reflector with a larger cavity diameter to source diameter ratio, as compared to that illustrated in FIG. 19. From the ray trace it can be observed that there is a concentration of rays in the center of the cavity. These constitute a virtual source—rays that exit the cavity will pass though this region before they exit. FIG. 21, illustrates an illumination system front end, where source 222 and the larger virtual source 222 created by lamp cavity 220 are imaged by optics 226 to a new source image 232. The superior phase-space (angle X position) properties of this source are show in FIG. 22. FIG. 22 shows the angle and position of a set of uniform source rays as they cross boundary A in FIG. 21. As one can see the phase space is evenly packed, and also empty gaps caused by transitions between different zones of the cavity are fairly small. The number in each ray's circle-point in FIG. 22 indicates the number of cavity bounces that ray underwent.

The arc lamp cavity of the present invention can be made using existing optical fabrication techniques. As an example, an arc lamp with a glass bulb is place in a cavity having three holes. Two holes accommodate the arc lamp electrodes, and the last hole serves at the aperture for the light to escape the lamp assembly. Since it is difficult to fabricate a fully concave surface (nearly spherical) with reflecting inner surface, a two piece construction can be employed. A seam between the two halves would cause some loss but it would be limited especially if located on the “equator” of the lamp assemble. Alternatively, it may be optimal to fabricate a glass bulb with the appropriate holes and then put a reflective coating on the outside surface. The arc lamp could then be slid into this cavity.

As another example, the cavity itself could be the vacuum housing for the arc lamp. Such a technique is employed in the prior art in the CERMAX series of arc lamps by Perkin Elmer. Instead of an elliptical or parabolic cavity however, a two piece astable near-spherical cavity could be constructed. Again a two price design would be practical. Because of the precision machining of the ceramic cavity, a very small seam can likely be achieved.

For enabling the proper operation of the illumination system, the arc cylinder needs to be positioned in the center of the cavity formed by the reflector. During operation, however, the arc cylinder may be moved, resulting in an offset from its desired position. To securing the arc cylinder at the desired position, an electromagnetic positioning technique can be employed. In particular, a pair of magnetic detectors (more can be used) are respectively positioned along X and Y directions proximate to the arc cylinder. The magnetic detectors dynamically detect signals that are predominantly determined by the distance between or angular position of the arc cylinder in relation to the magnetic detectors. Upon detecting a deviation from the desired values, additional electromagnetic forces are generated and applied to the arc cylinder to force the arc cylinder to resume its desired position.

The cavity exit can be made just large enough so that no ray emanating from the source becomes trapped in the cavity. If it is made larger that this minimum value, then the phase space will be less densely filled.

In addition to the rays from the arc cylinder, external rays may enter into the cavity of the arc lamp and be reflected by the reflector. An external ray entering into the reflector from inside the exit light cone of the reflector is reflected such that the ray converges towards the source and strikes the source after multiple reflections. The ray emerges from the arc lamp appears to be emanated from a virtual arc source at a location of the real arc source but with a larger surface area as compared to the area of the real arc source. For the ray entering into the cavity of the arc lamp from the outside of the light cone, the reflector of the arc lamp reflects the ray such that the ray escapes from the cavity eventually and appears to be emanated from the cavity having no arc source.

1. An illumination system comprising:
an arc source producing light; and
a reflector comprising a reflective surface that comprises a multiplicity of quadrants for collecting and reflecting the light from the arc source such that the light paths of the reflected light revolve about the arc source and converge to an output opening of the lamp.

2. The system of claim 1, wherein the reflective surface of the reflector is a continuous surface with an exit and entrance apertures.

3. The system of claim 1, wherein the arc source has a first phase space volume value, wherein the phase space is spanned by two free variables of the near field area and two free variables of the far field solid angle of the arc source; and wherein the reflector has a reflective surface for reflecting light from the arc source such that the phase space volume of the illumination system is from 100% to 200% to that of the arc source.

4. The system of claim 1, wherein the length of the arc source is not parallel to the length of the length of the aperture.

5. The system of claim 1, wherein the reflective surface of the reflector comprises a spiral surface.

6. The system of claim 1, wherein the reflective surface is constructed such that the light from the arc source evolves 2 or more rounds around the arc source before escaping from the reflector.

7. The system of claim 1, wherein the reflective surface is constructed such that the light from the arc source evolves 4 or more rounds around the arc source before escaping from the reflector.

8. The system of claim 5, wherein the spiral surface is selected from the group consisting of: Archimedean's spirals, circle involute spirals, clothoid spirals, concho-spirals, concho-spirals, continuous-line-illusion spirals, cornu-spirals, Cotes' spirals, Fermat's spirals, Fermat's spiral inverse curves, hyperbolic spirals, hyperbolic spiral inverses, hyperbolic spiral roulette curves, lituus spirals, lituus inverse curves, logarithmic spirals, logarithmic spiral catacaustic curves, logarithmic spiral evolutes curves, logarithmic spiral pedal curves, logarithmic spiral radial spirals, mice problem spirals, Nielsen's spirals, Phyllotaxis spirals, Poinsot's spirals, polygonal spirals, prime spirals, rational spirals, Seiffert's spherical spirals, sici spirals, sinusoidal spirals, sinusoidal spiral inverse spirals, sinusoidal spiral pedal curves, spherical spirals, and whirls.

9. The system of claim 5, wherein the reflective surface of the reflector further comprises a non-spiral surface that is a algebraic surface (e.g. quadric) or revolution surface.

10. The system of claim 1, wherein the reflective surface of the reflector forms a cavity that has an astable state in a plane and a stable state a direction perpendicular to said plane.

11. The system of claim 1, wherein the arc lamp is capable of emitting a cone of light wherein said cone has an angle of 20° degrees or less in a plane perpendicular to the arc axis, and 25° or more in a plane parallel to the arc axis;

12. The system of claim 1, further comprising: an adiabatic tapered light pipe in connection with the reflective cavity, wherein the light pipe has an input opening, the size of which is comparable to that of the output opening of the reflective cavity.

13. The system of claim 10, wherein the illumination system is a part of a projection system that further comprises a condensing lens for focusing the light from the illumination system onto a spatial light modulator that modulates the light.

14. The system of claim 10, wherein the illumination system is a part of a projection system in which a condensing optics is in absence from between the illumination system and the spatial light modulator.

15. The system of claim 1, wherein all parts in the reflective surface are substantially equidistant from the arc source.

16. The system of claim 5, wherein the spiral surface that can be described by the equation of:
$$θ = a \cdot π + b \cdot \sqrt{\frac{{r}^{2}}{{r}_{e}^{2}} - 1} + c \cdot \sqrt{\frac{{r}_{min}^{2} ( z )}{{r}_{e}^{2}} - 1} + d \cdot arccos ( \frac{{r}_{e}}{r} ) + g \cdot arccos ( \frac{{r}_{e}}{{r}_{min} ( z )} ) ,$$
wherein θ and r are variables; and a, b, c, d, g, rₑ, rₘᵢₙ, and rₘₐₓ are constants.

17. The system of claim 1, wherein the reflector comprises a multiplicity of quadrants for collecting and reflecting the light from the arc source such that the light paths of the reflected light revolve about the arc source and converge to an output opening of the lamp.

18. The system of claim 1, wherein the reflector comprises at least two groups quadrants for reflecting the light from the arc source, wherein one group of quadrants causes the light paths of the reflected light to revolve counter-clockwise about the arc source; and the other group of quadrants causes the light paths of the reflected light to revolve clockwise about the arc source

19. The system of claim 18, wherein the quadrants in different groups are arranged alternately to form a cavity.

20. The system of claim 18, wherein the light is reflected between the quadrants of the same group before exiting from the lamp.

21. The system of claim 1, wherein the light emitted from an edge point of the arc cylinder is operable to impinge perpendicularly the surface of the reflector when viewed along a direction parallel to the length of the arc cylinder, while the light impinges the surface with an angle when viewed along a direction perpendicular to the length of the arc cylinder.

22. The system of claim 21, wherein:
a) the light exits from an opening of the reflector forms a cone characterized by a solid angle;
b) the light enters into the cavity from outside the cone is converged towards the opening after multiple reflections; and
c) the light enters into the cavity from inside the cone converged onto the arc source.

23. The system of claim 22, wherein the distance between the arc source and the reflected light after each reflection is reduced.

24. The system of claim 1, wherein the reflector is constructed such that the light emitted from an edge point of the arc cylinder is reflected by the reflector away from the arc cylinder, and the distance between the arc cylinder and the reflected light increases after each reflection.

25. The system of claim 1, wherein the reflective surface of the reflector intercepts 70% or more of the solid angle of light emitted from the arc source.

26. The system of claim 1, wherein the system has a numerical aperture in a plane perpendicular to the arc axis of sin (20θ) or less, and sin (25°) or more in a plane parallel to the arc axis.

27. The system of claim 1, wherein the reflective surface has first and second two-folded symmetry with reference to a first and second planes passing through the center of the reflector.

28. The system of claim 1, wherein the reflector is positioned relative to the arc source such that the light impinges the reflective surface at an angle of from +25 to −25 degrees.

29. An illumination system, comprising:
an arc source for emitting light; and
a reflector having a reflective surface for reflecting the light from the arc source, wherein the reflector is positioned relative to the arc source such that the light impinges the reflective surface at an angle of from +25 to −25 degrees.

30. The system of claim 29, wherein a ratio of the minimum distance and the maximum distance between the reflective surface to the surface of the arc source is 80% or higher.

31. The system of claim 29, wherein a ratio of the minimum distance and the maximum distance between the reflective surface to the surface of the arc source is 95% or higher.

32. The system of claim 29, wherein the reflective surface of the reflector is a continuous surface with an exit and entrance apertures.

33. The system of claim 29, wherein the arc source has a first phase space volume value, wherein the phase space is spanned by two free variables of the near field area and two free variables of the far field solid angle of the arc source; and wherein the reflector has a reflective surface for reflecting light from the arc source such that the phase space volume of the illumination system is from 100% to 200% to that of the arc source.

34. The system of claim 29, wherein the length of the arc source is not parallel to the length of the length of the aperture.

35. The system of claim 29, wherein the reflective surface of the reflector comprises a spiral surface.

36. The system of claim 35, wherein the spiral surface is selected from the group consisting of: Archimedean's spirals, circle involute spirals, clothoid spirals, concho-spirals, concho-spirals, continuous-line-illusion spirals, cornu-spirals, Cotes' spirals, Fermat's spirals, and Fermat's spiral inverse curves.

37. The system of claim 35, wherein the spiral surface is selected from the group consisting of: hyperbolic spirals, hyperbolic spiral inverses, hyperbolic spiral roulette curves, lituus spirals, lituus inverse curves, logarithmic spirals, logarithmic spiral catacaustic curves, logarithmic spiral evolutes curves, logarithmic spiral pedal curves, logarithmic spiral radial spirals, and mice problem spirals.

38. The system of claim 35, wherein the spiral surface is selected from the group consisting of: Nielsen's spirals, Phyllotaxis spirals, Poinsot's spirals, polygonal spirals, prime spirals, rational spirals, Seiffert's spherical spirals, sici spirals, sinusoidal spirals, sinusoidal spiral inverse spirals, sinusoidal spiral pedal curves, spherical spirals, and whirls.

39. The system of claim 35, wherein the reflective surface of the reflector further comprises a non-spiral surface that is an algebraic surface (e.g. quadric) or revolution surface.

40. The system of claim 29, wherein the reflective surface of the reflector forms a cavity that has an astable state in a plane and a stable state a direction perpendicular to said plane.

41. The system of claim 29, wherein the arc lamp is capable of emitting a cone of light wherein said cone has an angle of 20° degrees or less in a plane perpendicular to the arc axis, and 25° or more in a plane parallel to the arc axis;

42. The system of claim 29, further comprising: an adiabatic tapered light pipe in connection with the reflective cavity, wherein the light pipe has an input opening, the size of which is comparable to that of the output opening of the reflective cavity.

43. The system of claim 29, wherein the illumination system is a part of a projection system that further comprises a condensing lens for focusing the light from the illumination system onto a spatial light modulator that modulates the light.

44. The system of claim 29, wherein the illumination system is a part of a projection system in which a condensing optics is in absence from between the illumination system and the spatial light modulator.

45. The system of claim 29, wherein all parts in the reflective surface are substantially equidistant from the arc source.

46. The system of claim 29, wherein the reflector covers 75% or more of the arc source surface but is spaced apart from the arc source.

47. The system of claim 29, wherein the reflector comprises a multiplicity of quadrants for collecting and reflecting the light from the arc source such that the light paths of the reflected light revolve about the arc source and converge to an output opening of the lamp.

48. The system of claim 29, wherein the reflector comprises at least two groups quadrants for reflecting the light from the arc source, wherein one group of quadrants causes the light paths of the reflected light to revolve counter-clockwise about the arc source; and the other group of quadrants causes the light paths of the reflected light to revolve clockwise about the arc source

49. The system of claim 48, wherein the quadrants in different groups are arranged alternately to form a cavity.

50. The system of claim 48, wherein the light is reflected between the quadrants of the same group before exiting from the lamp.

51. The system of claim 29, wherein the light emitted from an edge point of the arc cylinder is operable to impinge perpendicularly the surface of the reflector when viewed along a direction parallel to the length of the arc cylinder, while the light impinges the surface with an angle when viewed along a direction perpendicular to the length of the arc cylinder.

52. The system of claim 51, wherein:
a) the light exits from an opening of the reflector forms a cone characterized by a solid angle;
b) the light enters into the cavity from outside the cone is converged towards the opening after multiple reflections; and
c) the light enters into the cavity from inside the cone converged onto the arc source.

53. The system of claim 51, wherein the distance between the arc source and the reflected light after each reflection is reduced.

54. The system of claim 29, wherein the reflector is constructed such that the light emitted from an edge point of the arc cylinder is reflected by the reflector away from the arc cylinder, and the distance between the arc cylinder and the reflected light increases after each reflection.

55. The system of claim 29, wherein the reflective surface of the reflector intercepts 70% or more of the solid angle of light emitted from the arc source.

56. The system of claim 29, wherein the system has a numerical aperture in a plane perpendicular to the arc axis of sin(20°) or less, and sin (25°) or more in a plane parallel to the arc axis.

57. The system of claim 29, wherein the reflective surface has first and second two-folded symmetry with reference to a first and second planes passing through the center of the reflector.

58. An illumination system comprising:
an arc source for producing light; and
a reflector for reflecting the light, said reflector comprising a reflective surface that is constructed such that:
a) the light exits from an opening of the reflector forms a cone characterized by a solid angle;
b) the light enters into the cavity from outside the cone is converged towards the opening after multiple reflections; and
c) the light enters into the cavity from inside the cone converged onto the arc source.

59. The system of claim 58, wherein the reflector positioned proximate to the arc source, and comprises an aperture and a reflective surface that is not monotonically expanded such that the slope of the intersection of the a plane having the arc cylinder and crossing the aperture to the surface comprises both positive and negative values.

60. The system of claim 59, wherein the spiral surface is selected from the group consisting of: Archimedean's spirals, circle involute spirals, clothoid spirals, concho-spirals, concho-spirals, continuous-line-illusion spirals, cornu-spirals, Cotes' spirals, Fermat's spirals, and Fermat's spiral inverse curves.

61. The system of claim 59, wherein the spiral surface is selected from the group consisting of: hyperbolic spirals, hyperbolic spiral inverses, hyperbolic spiral roulette curves, lituus spirals, lituus inverse curves, logarithmic spirals, logarithmic spiral catacaustic curves, logarithmic spiral evolutes curves, logarithmic spiral pedal curves, logarithmic spiral radial spirals, and mice problem spirals.

62. The system of claim 59, wherein the spiral surface is selected from the group consisting of: Nielsen's spirals, Phyllotaxis spirals, Poinsot's spirals, polygonal spirals, prime spirals, rational spirals, Seiffert's spherical spirals, sici spirals, sinusoidal spirals, sinusoidal spiral inverse spirals, sinusoidal spiral pedal curves, spherical spirals, and whirls.

63. The system of claim 59, wherein the reflective surface of the reflector further comprises a non-spiral surface that is an algebraic surface or a revolution surface.

64. The system of claim 59, wherein the reflective surface of the reflector forms a cavity that has an astable state in a plane and a stable state a direction perpendicular to said plane.

65. The system of claim 59, wherein the reflector is positioned relative to the arc source such that the light impinges the reflective surface at an angle of from +25 to −25 degrees.

66. The system of claim 59, wherein the reflective surface comprises first and second two-folded symmetrical planes, said first and second symmetrical planes being perpendicular to each other.

67. An illumination system, comprising:
an arc source for emitting light; and
a reflector having a reflective surface for reflecting the light from the arc source, wherein the reflector has a two-folded bi-lateral symmetrical plane.

68. The system of claim 67, wherein the reflective surface is constructed such that the light emitted from an edge point of the arc source is operable to impinge perpendicularly the surface of the reflector when viewed along a direction parallel to the length of the arc cylinder, while the light impinges the surface with an angle when viewed along a direction perpendicular to the length of the arc cylinder.

69. The system of claim 67, wherein the reflective surface comprises a spiral surface that is selected from the group consisting of: Archimedean's spirals, circle involute spirals, clothoid spirals, concho-spirals, concho-spirals, continuous-line-illusion spirals, cornu-spirals, Cotes' spirals, Fermat's spirals, and Fermat's spiral inverse curves.

70. The system of claim 67, wherein the reflective surface comprises a spiral surface that is selected from the group consisting of: hyperbolic spirals, hyperbolic spiral inverses, hyperbolic spiral roulette curves, lituus spirals, lituus inverse curves, logarithmic spirals, logarithmic spiral catacaustic curves, logarithmic spiral evolutes curves, logarithmic spiral pedal curves, logarithmic spiral radial spirals, and mice problem spirals.

71. The system of claim 67, wherein the reflective surface comprises a spiral surface that is selected from the group consisting of: Nielsen's spirals, Phyllotaxis spirals, Poinsot's spirals, polygonal spirals, prime spirals, rational spirals, Seiffert's spherical spirals, sici spirals, sinusoidal spirals, sinusoidal spiral inverse spirals, sinusoidal spiral pedal curves, spherical spirals, and whirls.

72. The system of claim 67, wherein the reflective surface comprises a non-spiral surface that is an algebraic surface or a revolution surface.

73. The system of claim 67, wherein the reflective surface is positioned relative to the arc source such that the light impinges the reflective surface at an angle of from +25 to −25 degrees.

74. The system of claim 67, wherein the reflector has first and second two-folded bi-lateral symmetrical planes; wherein the first plane is a plane on which the direction of the length of the arc cylinder lies, and the second plane is a plane passes through the center of the arc cylinder and perpendicular to the first plane.
